(19) United States
(12) Patent Application Publication
(10) Pub. No.: US 2008/0302469 A1
(43) Pub. Date: Dec. 11, 2008

(54) Method for Producing a Closure Arrangement for a Vehicle Opening

(76) Inventors: Gerit Erbeck, Neuching (DE); Hubert Bohm, Grelfenberg (DE); Werner Patz, Hofstetten (DE)

Correspondence Address: DICKINSON WRIGHT PLLC, 1901 L. STREET NW, SUITE 800, WASHINGTON, DC, 20036, US

(21) Appl. No.: 11/913,253

(22) PCT Filed: May 31, 2006
(86) PCT No.: PCT/DE2006/000938

§ 371 Date: Jul. 22, 2008

(30) Foreign Application Priority Data
Jun. 1, 2005 (DE) 10 2005 025 163.3

(51) Int. Cl. B32B 37/00

(52) U.S. Cl. 156/229

(57) ABSTRACT

The invention relates to a method which is used to produce an arrangement for closing an opening of a vehicle. A sealed cavity is formed between a disk (10) and a splitter protection element (12), wherein a transparent sealing compound (14) is introduced in order to connect the splitter protection element to the disk by hardening the sealing compound, and the splitter protection element and the disk are connected to the vehicle body or to a maintaining element which can be connected to the vehicle body.

The present invention relates to a method for producing an arrangement for closing an opening of a vehicle, which presents a pane with a splinter protection element, where the opening can be, for example, a glass cover for a vehicle roof.

In DE 101 51 156 A1, a glass roof provided with a splinter protection film for a vehicle roof is described, where the splinter protection film is attached in its central area to a solar cell composite provided at the bottom side of the pane by lamination with a melt adhesive film, where the free marginal area of the splinter protection film, i.e., the marginal area that is not laminated to the pane, is connected to a holding element which can be connected to the vehicle body, and where this connection is achieved, for example, by mechanical means, i.e., by a screw or clamp connection, or by embedding the free splinter protection film margin in a surrounding foam which is provided on the roof margin, where, in the latter case, the free marginal area of the splinter protection film can be perforated to improve the adhesion in the surrounding foam. DE 36 32 472 A1 describes a similar structure.

Moreover, similar glass covers provided with a splinter protection film are also described in WO 2004/073976, where it is also mentioned that the splinter protection film can be glued to the pane by introducing an adhesive layer between the pane and the splinter protection film.

In the older German patent application with reference number 10 2004 015 920.3, a glass cover is described on whose bottom side a layer made of adhesive material is provided, which, on the one hand, itself already acts as a flat splinter protection element, i.e., without additional film or plate, and which, on the other hand, serves the function of gluing a reinforcement element, a holding element, or a screen directly to the pane.

Processes in which a splinter protection film is applied by lamination to the bottom side of the pane are very expensive due to the high visual requirements for the final product, and not lastly due to the required investments for equipment, i.e., the procurement of autoclaves.

Furthermore, in these processes, connecting parts, for example, frame parts, internal metal cover plates, or screens are generally connected with additional adhesive materials, for example, polyurethane, to the glass pane. In addition, means to increase the adhesion in the marginal area of the splinter protection film are usually required to allow a reliable connection of the splinter protection film to the vehicle body, or to a holding element which is connected to the vehicle body.

The problem of the present invention is to produce a method for producing an arrangement for closing an opening of the vehicle, where the arrangement should present a pane with a splinter protection function, and where the method should be designed in a particularly simple and cost effective way.

This problem is solved according to the invention by the methods defined in Claims 1, 18 and 19, respectively.

In principle, providing a splinter protection element which is connected directly to the vehicle body, or via a corresponding holding element, presents the advantage that, on the one hand, the splinter of the broken pane remains hanging on the splinter protection element, if the pane breaks, and, on the other hand, although the splinter protection element is no longer bending resistant if the pane is broken, it is kept at the same place by the holding element or by the car body, so that the passengers are not thrown out through the broken pane, objects and splinters cannot penetrate from outside through the broken pane into the inside cabin, and the inside cabin remains freely accessible if the pane is broken in the case of a break-in.

In the solution according to Claim 1 it is particularly advantageous that, because the splinter protection element is connected by means of a transparent sealing compound to the pane, an expensive lamination process can be avoided. Furthermore, it is possible to anchor holding elements or other connecting elements directly in the sealing compound, so that additional process steps for the connection of such elements can be omitted.

In the methods according to Claims 18 and 19 it is particularly advantageous that, because the transparent sealing compound itself acts as splinter protection element, no additional splinter protection elements in the form of a film or a plate are needed.

In the solution according to Claim 19 it is moreover particularly advantageous that, because a holding element for connecting the splinter protection element to the vehicle body is anchored in the sealing compound, i.e., the splinter protection element itself, the otherwise required additional step for the connection of the splinter protection element to the vehicle body can be omitted.

Preferred embodiments of the invention can be obtained from the dependent claims.

Below, the invention is explained in greater detail using an example with reference to the drawing in the appendix. In the drawing:

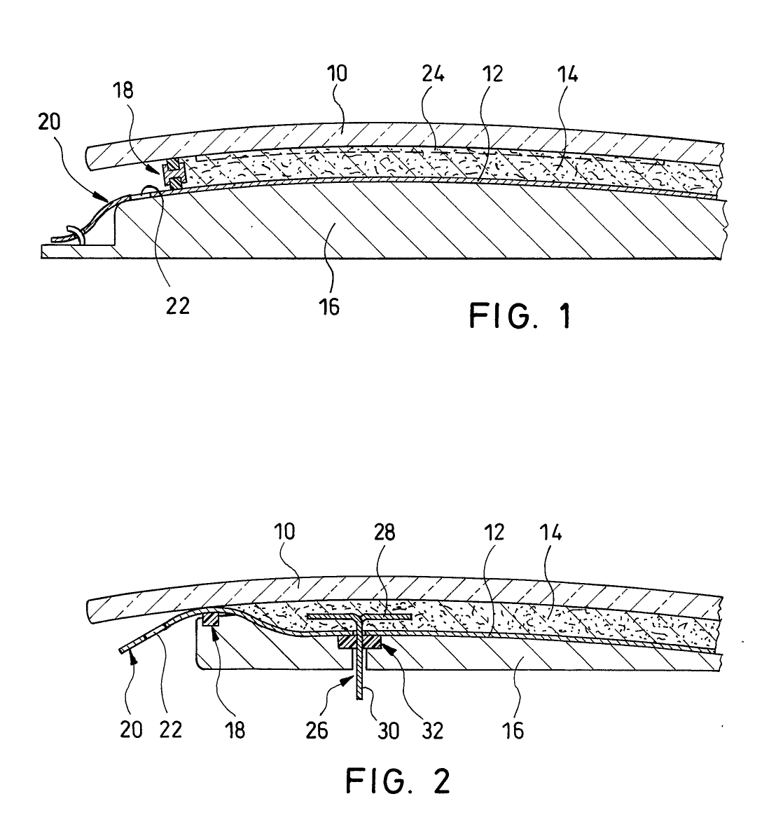

FIG. 1 shows a schematic cross-sectional view of a pane which is provided with a splinter protection film during the application of the splinter protection film to the pane;

FIG. 2 shows a view similar to FIG. 1, depicting an embodiment variant;

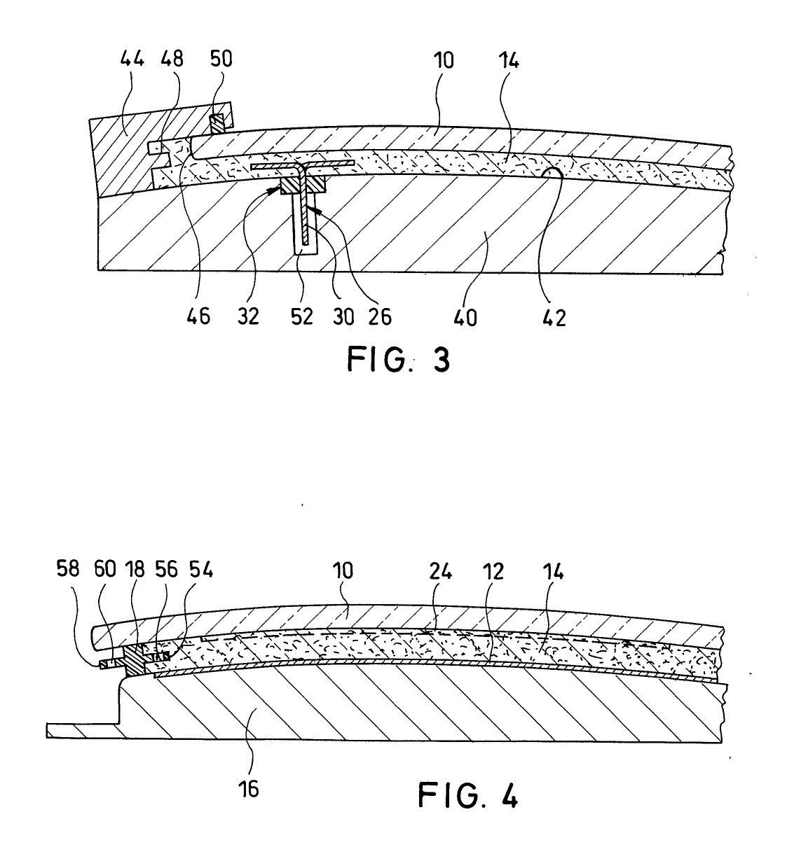

FIG. 3 shows a schematic cross-sectional view of a pane in during the forming of a sealing compound, which functions as splinter protection element, on the pane; and

FIG. 4 shows a view as in FIG. 1 depicting an embodiment variant.

FIG. 1 is a schematic representation of a glass cover for a vehicle, where a glass pane 10 is provided at its bottom side with a splinter protection film 12, by introducing a sealing compound 14 into a cavity formed between the bottom side of the pane 10 and the splinter protection film 12. The sealing compound 14 can be, for example, a cast resin. In principle, the cavity can be back injected or cast, for example, with the sealing compound 14.

The splinter protection film 12, during the introduction of the sealing compound 14 and until the latter has completely hardened, is stretched on a form 16, which presents a visually perfect surface on its side facing the splinter protection film 12, and which can be formed, for example, from another glass pane or from a polished surface. Laterally, the cavity is sealed by means of a sealing arrangement 18 which is located peripherally in the marginal area of the splinter protection film 12, where the sealing arrangement 18 at the same time functions as a spacer between the pane and splinter protection film 12. The sealing arrangement 18 is arranged in such a way that a free marginal section 20 of the splinter protection film 12 protrudes outward over the sealing arrangement, and is thus not connected to the pane 10.

The hardening of the sealing compound 14 can be achieved, for example, by UV radiation, heat addition, preferably in the form of IR radiation, or by the addition of a second component. After the hardening of the sealing compound 14, the pane 10, with the splinter protection film 12 attached to it by means of the sealing compound 14, can be removed from the form 16.

The splinter protection film 12 can be manufactured, for example, from PET, PC or PMMA, and it is preferably provided with a scratch-resistant coating on its side turned away from the pane 10.

The protruding marginal area 20 of the splinter protection film serves the function of connecting the splinter protection film 12 directly with the vehicle body, or with the holding element that can be connected to the vehicle body. Such a connection can be achieved, for example, purely mechanically, i.e., by means of a screw or a clamp connection, by gluing, or by surrounding with a foam. If the connection is made by gluing or by surrounding with foam, the free marginal area 20 of the splinter protection film 12 is preferably provided with means to increase the adhesion of the gluing or the surrounding foam, for example, with holes 22, through which the glue or the surrounding foam composition can pass to anchor the splinter protection film 12 in the glue or the surrounding foam.

In principle, it is possible to provide in the area between the glass pane 10 and the splinter protection film 12, a functional element, for example, a solar cell composite, switchable films based on an SPD (Suspended Particle Device) or on EC (electrochromism) or on luminescent films based on EL (electroluminescence) or LED surfaces (diode arrangements). This can be achieved, for example, by attaching, before the formation of the cavity, a functional element 24, as indicated in FIG. 1 with broken lines, to the side of the pane which faces the splinter protection film 12. Alternatively, the functional element 24 could be introduced into the cavity and embedded in the sealing compound 14.

FIG. 2 depicts an embodiment variant, in which the peripheral sealing arrangement 18 is not formed as a spacer, rather its function is to press the splinter protection film 12 against the bottom side of the pane 10 sufficiently firmly so that the sealing compound 14 is prevented from advancing to the free marginal section 20 of the splinter protection film 12.

Furthermore, FIG. 2 shows how a connecting element 26 is anchored with its upper section 28 in the sealing compound 14 at the time of the introduction and the hardening of the sealing compound 14 in the sealing compound to ensure a connection between the splinter protection film 12 and the connecting element 26. A part 30 of the connecting element 26 passes through the splinter protection film 12, where the form 16 presents a sealing device 32 which is arranged at the perforation place and serves the function of sealing the connecting element 26 with respect to the sealing compound 14.

In principle, the connecting element 26 could also be a holding element by means of which the splinter protection film 12 is connected to the vehicle body. In this case, no protruding marginal section 20 of the splinter protection film 12 would be needed.

FIG. 3 shows an embodiment in which the sealing compound 14, after it has hardened, functions itself as splinter protection element, so that a separate splinter protection film 12 is no longer needed. In this embodiment, the pane 10 is placed in a tool so that a sealed cavity is formed between the pane 10 and a tool part 40, into which the transparent sealing compound 14 is introduced. The tool part 40, on its side facing the pane 10, presents a surface which is visually perfect and formed preferably from a polished surface. The surface 42 here acts as form for the sealing compound 14.

Furthermore, the tool part 40 presents a sealing frame 44, which is designed to form the sealing compound 14 on the marginal edge 46 of the pane 10. The sealing frame 44 is designed preferably so that the sealing compound 14 which is formed on the marginal edge 46 of the pane 10 is provided, after removal from the form, with a groove 48 for receiving a seal (not shown). The sealing frame 44, moreover, presents a seal 50 to prevent the sealing compound 14 from advancing to the upper side of the pane 10.

In a manner similar to the embodiment according to FIG. 2, the embodiment according to FIG. 3 provides a connecting element 26, which can be a holding element, in which the sealing compound 14 is anchored after it has hardened. The tool part 40 here presents a recess 52 for receiving the part 30 of the connecting element 26, which part is not to be anchored in the sealing compound 14, as well as a corresponding sealing device 32 which prevents the sealing compound 14 from advancing to the part 30 of the connecting element 26, which part is not to be anchored.

FIG. 4 shows a variant of FIG. 1, in which the sealing arrangement 18 which functions as spacer is designed so that, after the hardening of the sealing compound 14, it is anchored in the sealing compound by means of a section 54, which is provided for this purpose with holes 56. The sealing arrangement 18 thus remains as an “expendable sealing” 10 in the sealing compound 14 and it acts as a connecting element, which can function, for example, as a holding element for the cover formed by the pane 10, and which can be provided for this purpose with the holes 60 in its free section 58.

The concept of the “expendable sealing” can also be used, for example, in the embodiment of FIG. 3.

In principle, in the invention, the cavity can be closed before the introduction of the sealing compound, in which case one must then ensure appropriate ventilation, for example, by removal by suction, or the sealing compound can be introduced into the bottom part of the cavity while it is still open, and the cavity can then be closed only after it has been filled with the sealing compound.

### LIST OF REFERENCE NUMERALS

10 pane.
12 splinter protection element.
14 sealing compound.
16 form.
18 sealing arrangement.
20 free marginal section of 12.
22 holes in 20.
24 functional element.
26 connecting element/holding element.
28 anchored part of 26.
30 free part of 30.
32 sealing device.
40 tool part.
42 surface of 40.
44 sealing frame.
46 marginal edge of 10.
48 groove in 44.
50 seal.
52 recess in 40.
54 anchoring section.
56 anchoring holes.
58 free section.
60 attachment holes.

1. A method for producing an arrangement for closing an opening of a vehicle, where, between a pane and a splinter protection element, a sealed cavity is formed, into which a transparent sealing compound is introduced, in order to connect the splinter protection element to the pane by hardening a sealing compound, the splinter protection element and the pane are connected to the vehicle body, or to a holding element which can be connected to the vehicle body.

2. The method of claim 1, characterized in that the splinter protection element, during the introduction and the hardening of the sealing compound, is stretched with its side that is turned away from the sealing compound onto a form.

3. The method of claim 2, characterized in that the form presents a visually perfect surface on the side facing the splinter protection element.

4. The method according to of claim 3, characterized in that the visually perfect surface is formed from an additional pane or from a polished surface.

5. The method of claim 1, characterized in that the cavity is sealed by means of a sealing arrangement which is arranged peripherally in the marginal area of the splinter protection element.

6. The method of claim 5, characterized in that the sealing arrangement is given dimensions such that a free marginal section of the splinter protection element protrudes outward over the sealing arrangement.

7. The method of claim 6, characterized in that the connection of the splinter protection element to the vehicle body, or to the holding element which can be connected to the vehicle body, occurs in the free marginal section of the splinter protection element.

8. The method of claim 7, characterized in that the connection of the splinter protection element to the vehicle body, or to the holding element which can be connected to the vehicle body, occurs by means of purely mechanical connection, by gluing, or by surrounding with foam.

9. The method of claim 8, characterized in that the free marginal section of the splinter protection element is provided by means to increase the adhesion, or by gluing, or by surrounding with foam.

10. The method of claim 9, characterized in that the means to increase the adhesion are holes in the splinter protection element to allow the passage of glue or the surrounding foam compound.

11. The method claim 1, characterized in that, during the introduction and the hardening of the sealing compound, a connecting element is anchored in the sealing compound, to connect the connecting element to the pane.

12. The method of claim 11, to the extent that reference is made to claim 2, characterized in that the form presents a sealing device for the purpose of sealing the splinter protection element at the place, where the connecting element passes through the splinter protection element, or of the sealing compound.

13. The method of claim 1, characterized in that the holding element which can be connected to the vehicle body is anchored in the sealing compound during the introduction and the hardening of the sealing compound, to connect the splinter protection element to the holding element.

14. The method of claim 13, to the extent that reference is made to claim 2, characterized in that the form presents a sealing device for the purpose of sealing the splinter protection element at the place, where the holding element passes through the splinter protection element, or of the sealing compound.

15. The method of claim 1, characterized in that, during the formation of the cavity, spacers are introduced between the pane and the splinter protection element.

16. The method of claim 15, characterized in that the cavity is sealed by means of a sealing arrangement which is arranged peripherally in the marginal area of the splinter protection element, where the sealing arrangement is designed as a spacer.

17. The method of claim 1, characterized in that the splinter protection element is a film made of PET, PC or PMMA.

18. A method for producing an arrangement for closing an opening of a vehicle, where a pane is placed in a tool in such a way that a sealed cavity is formed between the pane and a tool part, into which cavity a transparent sealing compound is introduced, to form a splinter protection element for the pane, where the pane, which is provided with the splinter protection element, is removed from the tool after the sealing compound has hardened, and where the pane which is provided with the splinter protection element, and the splinter protection element, can be connected directly with the vehicle body, or with a holding element which can be connected to the vehicle body.

19. A method for producing an arrangement for closing an opening of a vehicle, where a pane is placed in a tool in such a way that a sealed cavity is formed between the pane and a tool part, into which cavity a transparent sealing compound is introduced, to form a splinter protection element for the pane, where a holding element, which can be connected to the vehicle body, is anchored in the sealing compound, for connecting the splinter protection element to the holding element, where the pane, which is provided with the splinter protection element, is removed from the tool after the sealing compound has hardened, and where the pane, which is provided with the splinter protection element, can be connected by means of the holding element to the vehicle body.

20. The method of claim 18, characterized in that the cavity-forming tool part presents a sealing frame, which runs peripherally around the marginal edge of the pane, and which is designed to form the sealing compound on the marginal edge of the pane.

21. The method according to of claim 20, characterized in that the sealing frame is designed so that the sealing compound which is formed on the marginal edge is provided with a groove for receiving a seal.

22. The method of claim 18, characterized in that the cavity-forming tool part presents, on the side facing the pane, a visually perfect surface.

23. The method of claim 22, characterized in that the visually perfect surface is formed from a polished surface.

24. The method of claim 18, characterized in that, during the introduction and the hardening of the sealing compound, a connecting element is anchored in the sealing compound to connect the connecting element to the pane.

25. The method of claim 24, characterized in that the cavity-forming tool part presents a recess for receiving the part of the connecting element, which part is not to be anchored in the sealing compound, as well as a corresponding sealing device, which prevents the sealing compound from advancing to the part of the connecting element, which part is not to be anchored in the sealing compound.

26. The method of claim 1, characterized in that the sealing compound is a UV-hardening, a heat-hardening, or a two-component-hardening compound.

27. The method of claim 1, characterized in that the cavity is backmolded or backfilled with the sealing compound.

28. The method of claim 1, characterized in that a functional element is applied to the side of the pane facing the sealing compound before the formation of a cavity.

29. The method of claim 1, characterized in that a functional element is introduced into the cavity and embedded in the sealing compound.

30. The method of claim 28, characterized in that the functional element (is a solar cell composite, switchable films based on an SPD (Suspended Particle Device) or EC (electrochromism) or luminescent films based on EL (electroluminescence) or LED surfaces.

31. The method of claim 1, characterized in that the sealing compound is a cast resin.

32. The method of claim 1, characterized in that the opening is a roof opening, and the pane forms a glass cover.

33. The method of claim 1, characterized in that a sealing arrangement is provided for sealing the cavity, and it is anchored after the hardening of the sealing compound in the sealing compound, and acts as a connecting element, particularly a holding element.

34. The method of claim 33, characterized in that the sealing arrangement, in the section which engages in the sealing compound, is provided with holes for anchoring in the sealing compound.

35. The method of claim 33, characterized in that the sealing arrangement peripherally seals the sealing compound at the lateral margin.
